(19) United States
(12) Patent Application Publication
(10) Pub. No.: US 2011/0193280 A1
(43) Pub. Date: Aug. 11, 2011

(54) Rotatable workbench with a multi-face working function

(76) Inventor: Chin-Kun Yu, Feng-Yuan City (TW)

(21) Appl. No.: 12/838,478

(22) Filed: Jul. 18, 2010

(30) Foreign Application Priority Data
Feb. 10, 2010 (TW) 099202781

(51) Int. Cl. B23Q 3/00; B25B 11/00

(52) U.S. Cl. 269/61; 269/58; 269/71

(57) ABSTRACT

A workbench includes a support base, a rotation disk rotatably mounted on the support base, a rotation seat mounted on the support base and rotated by the rotation disk, and a working table swivelably mounted on the rotation seat. The working table has two opposite working zones each having a recessed and tapered profile. Thus, the working table on the rotation seat has two working zones so that when the workpiece is positioned, the working tool can be used to directly work the two opposite faces of the workpiece by rotation of the rotation seat and the working table without having to turn and reposition the workpiece, thereby saving the working time, decreasing the cost of fabrication and enhancing the working efficiency.

### BACKGROUND OF THE INVENTION

1. Field of the Invention

The present invention relates to a workbench and, more particularly, to a workbench that is used to clamp and work a workpiece.

2. Description of the Related Art

A conventional workbench comprises a table and a clamp mounted on the table to receive and clamp a workpiece. Thus, the workpiece positioned by the clamp can be worked by a working tool, such as a turning tool, cutter, grinding tool and the like. However, the conventional workbench can be used to work one lace of the workpiece only, and when the operator needs to work the other face of the workpiece, it is necessary to remove, invert and reposition the workpiece, thereby causing inconvenience to the operator and thereby increasing the working time and decreasing the working efficiency. In addition, when the conventional workbench is used to work the two opposite faces of the workpiece, it is necessary to reposition the workpiece, thereby decreasing the working precision of the workpiece and greatly increasing the calibration time of the workpiece. Further, the conventional workbench cannot be used to work and form arc-shaped faces on the workpiece.

### BRIEF SUMMARY OF THE INVENTION

In accordance with the present invention, there is provided a workbench, comprising a support base, a rotation disk rotatably mounted on the support base, a rotation seat mounted on the support base and rotated by the rotation disk, and a working table swivelably mounted on the rotation seat. The working table has two working zones which are formed on two opposite sides of the working table respectively. Each of the two working zones of the working table has a recessed and tapered profile.

The workbench further comprises a bottom board mounted on a bottom of the support base, an upright support plate mounted on the bottom board and spaced from the support base to support the rotation seat, and a pivot seat mounted on the support plate and connected with the rotation seat to pivotally mount the rotation seat onto the support plate. Each of the two working zones or the working table has a tapered thickness that is reduced gradually from a periphery of the working table to a center of the working table. Each of the two working zones of the working table has a peripheral wall formed with an oblique guide face. The workbench further comprises a press ring mounted in the working table to position a workpiece. The working table has an inner portion formed with a stepped mounting recess to receive the press ring and the workpiece. The workbench further comprises, a driving mechanism mounted between the rotation seat and the working table to drive the working table to swivel relative to the rotation seat. The driving mechanism includes a worm mounted on the rotation seat and a worm wheel mounted on the working table and meshing with the worm. Thus, when the worm is rotated, the worm wheel is rotated by the worm to drive the working table to swivel relative to the rotation seat. The rotation seat is pivotally connected with the support plate by the pivot seat. The rotation seat is disposed between the rotation disk and the support plate. The rotation seat has a first end locked onto the rotation disk to rotate in concert with the rotation disk and a second end pivotally mounted on the support plate by a bearing. The rotation seat is rotatable relative to the support base about a horizontal axis. The working table is rotatable relative to the rotation seat about a vertical axis so that the working table has a rotation direction that is perpendicular that of the rotation seat. The mounting recess of the working table is disposed between the two working zones of the working table. The bottom board is disposed between the support base and the support plate. The bottom board has a first end connected with the support base and a second end connected with the support plate. The bottom board is spaced from the working table and the rotation seat. The bottom board faces one of the two working zones of the working table.

The primary objective of the present invention is to provide a rotatable workbench with a multi-face working function.

According to the primary advantage of the present invention, the working table on the rotation seat has two working zones so that when the workpiece is positioned by the press ring, the working tool can be used to directly work the two opposite faces of the workpiece by rotation of the rotation seat and the working table without having to turn and reposition the workpiece, thereby saving the working time, decreasing the cost of fabrication and enhancing the working efficiency.

According to another advantage of the present invention, when the rotation seat is rotated relative to the support base, the working table is disposed at an inclined position so that the workpiece is inclined at a determined angle, and the working tool can directly work the workpiece to form oblique or arc-shaped faces on the workpiece.

According to a further advantage of the present invention, when the workpiece is positioned on the working table, the working tool can directly work the two opposite faces of the workpiece and form oblique or arc-shaped faces on the workpiece by rotation of the rotation seat so that the operator only needs to position the workpiece at the first time and needs not to remove, invert and reposition the workpiece so as to facilitate the operator working the workpiece, to keep the working precision of the workpiece and to greatly shorten the calibration time of the workpiece.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a workbench in accordance with the preferred embodiment of the present invention.

FIG. 2 is a partially perspective view of the workbench as shown in FIG. 1.

FIG. 3 is a front cross-sectional operational view of the workbench as shown in FIG. 1 in use.

### DETAILED DESCRIPTION OF THE INVENTION

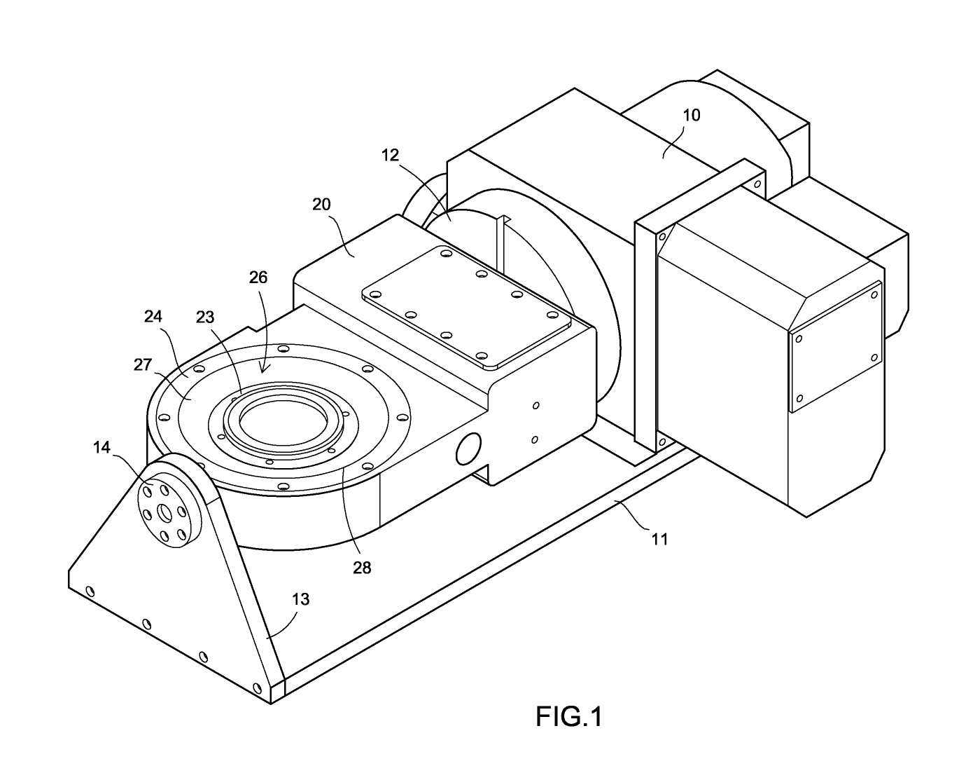

Referring to the drawings and initially to FIGS. 1-3, a workbench in accordance with the preferred embodiment of the present invention comprises a support base 10, a rotation disk 12 rotatably mounted on the support base 10, a rotation seat 20 mounted on the support base 10 and rotated by the rotation disk 12, a working table 24 swivelably mounted on the rotation seat 20, a press ring 23 mounted in the working table 24 to position a workpiece 30, a bottom board 11 mounted on a bottom of the support base 10, an upright support plate 13 mounted on the bottom board 11 and spaced from the support base 10 to support the rotation seat 20, a pivot seat 14 mounted on the support plate 13 and connected with the rotation seat 20 to pivotally mount the rotation seat 20 onto the support plate 13, and a driving mechanism 25 mounted between the rotation seat 20 and the working table 24 to drive the working table 24 to swivel relative to the rotation seat 20.

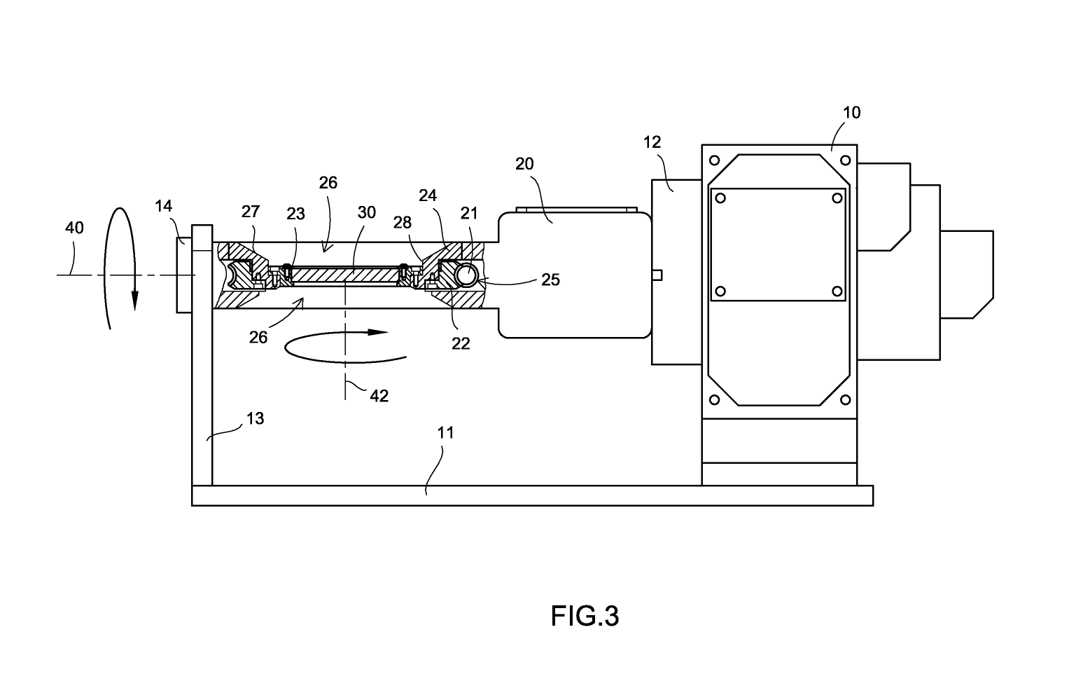

The rotation seat 20 is rotatable relative to the support base 10 about a horizontal axis 40 as shown in FIG. 3. The rotation seat 20 is pivotally connected with the support plate 13 by the pivot seat 14. The rotation seat 20 is disposed between the rotation disk 12 and the support plate 13 and has a first end locked onto the rotation disk 12 to rotate in concert with the rotation disk 12 and a second end pivotally mounted on the support plate 13 by a bearing.

The working table 24 is rotatable relative to the rotation seat 20 about a vertical axis 42 as shown in FIG. 3 so that the working table 24 has a rotation direction that is perpendicular that of the rotation seat 20. The working table 24 has two working zones 26 which are formed on two opposite sides of the working table 24 respectively. Each of the two working zones 26 of the working table 24 has a recessed and tapered profile and has a tapered thickness that is reduced gradually from a periphery of the working table 24 to a center of the working table 24. Each of the two working zones 26 of the working table 24 has a peripheral wall formed with an oblique guide face 27. The working table 24 has an inner portion formed with a stepped mounting recess 28 to receive the press ring 23 and the workpiece 30. The mounting recess 28 of the working table 24 is disposed between the two working zones 26 of the working table 24.

The driving mechanism 25 includes a worm 21 mounted on the rotation seat 20 and a worm wheel 22 mounted on the working table 24 and meshing with the worm 21. Thus, when the worm 21 is rotated, the worm wheel 22 is rotated by the worm 21 to drive the working table 24 to swivel relative to the rotation seat 20.

The bottom board 11 is disposed between the support base 10 and the support plate 13 and has a first end connected with the support base 10 and a second end connected with the support plate 13. The bottom board 11 is spaced from the working table 24 and the rotation seat 20 and faces one of the two working zones 26 of the working table 24.

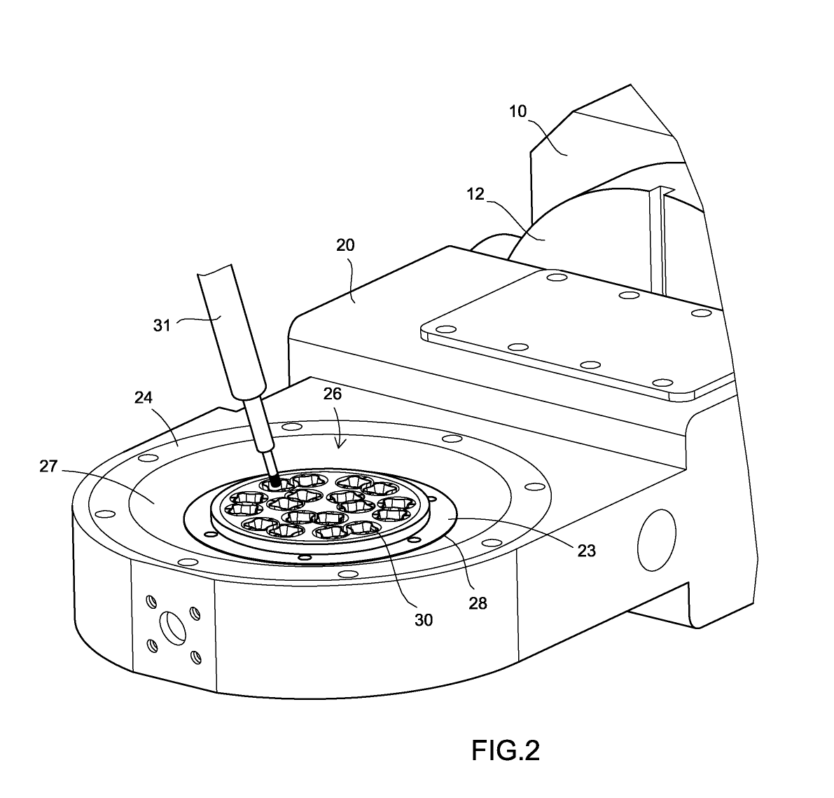

In operation, referring to FIG. 3 with reference to FIGS. 1 and 2, when the workpiece 30 is placed into the working table 24, the workpiece 30 is positioned in place by the press ring 23 so that the workpiece 30 can be worked by a working tool 31, such as a turning tool, cutter, grinding tool and the like. In such a manner, when the working table 24 is rotated relative to the rotation seat 20 about the vertical axis 42, the workpiece 30 on the working table 24 can be rotated about the vertical axis 42 to be worked by the working tool 31 in a horizontal manner. Thus, the front face of the workpiece 30 can be worked by the working tool 31. In addition, when the rotation seat 20 is rotated relative to the support base 10 about the horizontal axis 40, the working table 24 is also rotated about the horizontal axis 40, so that the workpiece 30 on the working table 24 can be rotated about the horizontal axis 40 to be worked by the working tool 31 in an inclined manner. In addition, when the rotation seat 20 is rotated relative to the support base 10 through one hundred and eighty degrees (180°), the back face of the workpiece 30 can be worked by the working tool 31.

Accordingly, the working table 24 on the rotation seat 20 has two working zones 26 so that when the workpiece 30 is positioned by the press ring 23, the working tool 31 can be used to directly work the two opposite faces of the workpiece 30 by rotation of the rotation seat 20 and the working table 24 without having to turn and reposition the workpiece 30, thereby saving the working time, decreasing the cost of fabrication and enhancing the working efficiency. In addition, when the rotation seat 20 is rotated relative to the support base 10, the working table 24 is disposed at an inclined position so that the workpiece 30 is inclined at a determined angle, and the working tool 31 can directly work the workpiece 30 to form oblique or arc-shaped faces on the workpiece 30. Further, when the workpiece 30 is positioned on the working table 24, the working tool 31 can directly work the two opposite faces of the workpiece 30 and form oblique or arc-shaped faces on the workpiece 30 by rotation of the rotation seat 20 so that the operator only needs to position the workpiece 30 at the first time and needs not to remove, invert and reposition the workpiece 30 so as to facilitate the operator working the workpiece 30, to keep the working precision of the workpiece 30 and to greatly shorten the calibration time of the workpiece 30.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A workbench, comprising:
a support base;
a rotation disk rotatably mounted on the support base;
a rotation seat mounted on the support base and rotated by the rotation disk;
a working table swivelably mounted on the rotation seat;
wherein the working table has two working zones which are formed on two opposite sides of the working table respectively;
each of the two working zones of the working table has a recessed and tapered profile.

2. The workbench of claim 1, wherein
the workbench further comprises:
a bottom board mounted on a bottom of the support base;
an upright support plate mounted on the bottom board and spaced from the support base to support the rotation seat;
a pivot seat mounted on the support plate and connected with the rotation seat to pivotally mount the rotation seat onto the support plate.

3. The workbench of claim 1, wherein each of the two working zones of the working table has a tapered thickness that is reduced gradually from a periphery of the working table to a center of the working table.

4. The workbench of claim 1, wherein each of the two working zones of the working table has a peripheral wall formed with an oblique guide face.

5. The workbench of claim 1, wherein
the workbench further comprises a press ring mounted in the working table to position a workpiece;
the working table has an inner portion formed with a stepped mounting recess to receive the press ring.

6. The workbench of claim 1, wherein the workbench further comprises:
a driving mechanism mounted between the rotation seat and the working table to drive the working table to swivel relative to the rotation seat.

7. The workbench of claim 6, wherein the driving mechanism includes:
a worm mounted on the rotation seat;
a worm wheel mounted on the working table and meshing with the worm;
when the worm is rotated, the worm wheel is rotated by the worm to drive the working table to swivel relative to the rotation seat.

8. The workbench of claim 2, wherein the rotation seat is pivotally connected with the support plate by the pivot seat.

9. The workbench of claim 2, wherein the rotation seat is disposed between the rotation disk and the support plate.

10. The workbench of claim 9, wherein the rotation seat has a first end locked onto the rotation disk to rotate in concert with the rotation disk and a second end pivotally mounted on the support plate by a bearing.

11. The workbench of claim 1, wherein
the rotation seat is rotatable relative to the support base about a horizontal axis;
the working table is rotatable relative to the rotation seat about a vertical axis;
the working table has a rotation direction that is perpendicular that of the rotation seat.

12. The workbench of claim 5, wherein the mounting recess of the working table is disposed between the two working zones of the working table.

13. The workbench of claim 2, wherein the bottom board is disposed between the support base and the support plate.

14. The workbench of claim 13, wherein the bottom board has a first end connected with the support base and a second end connected with the support plate.

15. The workbench of claim 2, wherein the bottom board is spaced from the working table and the rotation seat.

16. The workbench of claim 2, wherein the bottom board faces one of the two working zones of the working table.
